(19) United States
(12) Patent Application Publication
(10) Pub. No.: US 2026/0067454 A1
(43) Pub. Date: Mar. 5, 2026

(54) Post-Reconstruction Filtering Syntax Prediction

(71) Applicant: Google LLC, Mountain View, CA (US)

(72) Inventors: Lin Zheng, Waterloo (CA); Jingning Han, Santa Clara, CA (US); Yaowu Xu, Saratoga, CA (US)

(21) Appl. No.: 19/317,051

(22) Filed: Sep. 2, 2025

Related U.S. Application Data
(60) Provisional application No. 63/689,028, filed on Aug. 30, 2024.
(60) Provisional application No. 63/694,080, filed on Sep. 12, 2024.

(51) Int. Cl. H04N 19/117; H04N 19/172; H04N 19/44; H04N 19/80

(52) U.S. Cl. CPC H04N 19/117; H04N 19/172; H04N 19/44; H04N 19/80

(57) ABSTRACT

A first flag in a frame header of a current frame indicates whether a post-reconstruction filtering process is performed for the current frame. When the process is performed, a second flag indicates whether a post-reconstruction filtering syntax for the post-reconstruction filtering process of a previously decoded frame is reused for the current frame. The post-reconstruction filtering syntax can be a frame-level syntax or a block-level syntax. When the second flag indicates that frame-level post-reconstruction filtering syntax of the previously decoded frame is reused for the current frame, a third flag may indicate whether the block-level post-reconstruction filtering syntax of a previously decoded frame is reused for the current frame. The post-reconstruction filtering syntax, whether the frame-level, the block-level, or both, is used for the post-reconstruction filtering process unless new syntax is coded for the current frame.

### CROSS-REFERENCES TO RELATED APPLICATIONS

This application claims priority to and the benefit of U.S. Provisional Application Nos. 63/689,028, filed Aug. 30, 2024, and 63/694,080, filed Sep. 12, 2024, each of which is incorporated in its entirety by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

An aspect of the disclosed implementations is an apparatus including a processor. The processor is configured to decode, from an encoded bitstream, a flag indicating whether a post-reconstruction filtering syntax for a post-reconstruction filtering process of a previously decoded frame is reused for the current frame. In response to determining that the post-reconstruction filtering syntax of the previously decoded frame is not reused, the processor is configured to decode, from the encoded bitstream, a post-reconstruction filtering syntax of the current frame. In response to determining that the post-reconstruction filtering syntax is reused, the processor is configured to use the post-reconstruction filtering syntax for the post-reconstruction filtering process of the previously decoded frame as the post-reconstruction filtering syntax of the current frame. The processor is further configured to reconstruct the current frame and perform the post-reconstruction filtering process of the current frame using the post-reconstruction filtering syntax of the current frame.

Another aspect of the disclosed implementations is another apparatus including a processor. The processor is configured to decode, from an encoded bitstream, a first flag indicating whether a post-reconstruction filtering process is enabled for a current frame. In response to determining that the post-reconstruction filtering process is not enabled, the processor is configured to reconstruct the current frame without using the post-reconstruction filtering process. In response to determining that the post-reconstruction filtering process is enabled, the processor is configured to decode, from the encoded bitstream, a second flag indicating whether a post-reconstruction filtering syntax for the post-reconstruction filtering process of a previously decoded frame is reused for the current frame. In response to determining that the post-reconstruction filtering syntax for the post-reconstruction filtering process of the previously decoded frame is not reused, the processor is configured to decode, from the encoded bitstream, a post-reconstruction filtering syntax for the current frame. In response to determining that the post-reconstruction filtering syntax is reused, the processor is configured to use the post-reconstruction filtering syntax for the previously decoded frame as the post-reconstruction filtering syntax for the current frame. The processor is further configured to reconstruct the current frame and perform the post-reconstruction filtering process using the post-reconstruction filtering syntax for the current frame.

Another aspect of the disclosed implementations is a method. The method includes decoding, from an encoded bitstream, a first flag indicating that a post-reconstruction filtering process is enabled for the current frame, and decoding, from the encoded bitstream, a second flag indicating to reuse a post-reconstruction filtering syntax used for the post-reconstruction filtering process of a previously decoded frame. The method further includes reconstructing a current frame and filtering a block of the current frame after reconstruction using the post-reconstruction filtering syntax.

Another aspect of the disclosed implementations is a non-transitory, computer-readable storage medium storing a compressed bitstream comprising encoded residual data corresponding to blocks of multiple frames of a video sequence, a first flag that indicates a post-reconstruction filtering process for a current frame is enabled, a second flag that indicates whether to reuse a post-reconstruction filtering syntax for a previously coded frame for the post-reconstruction filtering process for a current frame, and where the second flag indicates to not reuse the post-reconstruction filtering syntax for the previously coded frame, a post-reconstruction filtering syntax for the post-reconstruction filtering process of the current frame.

Another aspect of the disclosed implementations is another method. The method includes encoding, into a compressed bitstream, a current frame, determining whether to reuse a post-reconstruction filtering syntax for a post-reconstruction filtering process of a previously encoded frame for the post-reconstruction filtering process of the current frame, encoding, into the compressed bitstream, a first flag indicating to filter the current frame using the post-reconstruction filtering process, and encoding, into the compressed bitstream, a second flag indicating whether to reuse the post-reconstruction filtering syntax for the post-reconstruction filtering process of the current frame.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is an illustration of examples of portions of a video frame.

FIG. 7 is a block diagram of an example of a video frame filtering stage.

FIG. 8 is a block diagram that illustrates the operations of a Cross-Component Sample Offset (CCSO) filter.

FIG. 9 illustrates syntax elements that may be used to signal aspects of the CCSO filter.

FIG. 10 illustrates syntax elements that may be used to signal aspects of a Constrained Directional Enhancement Filter (CDEF).

FIG. 11 is a flowchart of a technique for predicting the syntax for a post-reconstruction filtering process.

FIG. 12 is a flowchart of another technique for predicting the syntax for a post-reconstruction filtering process.

### DETAILED DESCRIPTION

Video compression schemes may include breaking respective images, or frames, of a video stream into smaller portions, such as blocks, or coding tree units (CTUs), and generating an encoded bitstream using techniques to limit the information included for respective CTUs thereof. The bitstream can be decoded to re-create the source frames from the limited information. Encoding CTUs to or decoding CTUs from a bitstream can include predicting the values of pixels or CTUs based on similarities with other pixels or CTUs in the same frame which have already been coded. Those similarities can be determined using intra prediction, which attempts to predict the pixel values of a coding unit (CU) of a CTU using pixels peripheral to the CU (e.g., pixels that are in the same frame as the CU, but which are outside the CU). During encoding, the result of an intra-prediction mode performed against a CU is a prediction unit (PU). A prediction residual can be determined based on a difference between the pixel values of the CU and the pixel values of the PU. The prediction residual and the intra prediction mode used to ultimately obtain that prediction residual can then be encoded to a bitstream. During decoding, the prediction residual is reconstructed into a CU using a PU produced based on the intra prediction mode and is thereafter included in an output video stream.

A CU includes a luminance, also referred to as luma, component and two chrominance, also referred to as chroma, components. These luma and chroma components may in some cases be referred to as a luma block and chroma blocks. The luma component of a CU may, for example, be expressed within a Y component (also referred as “plane”) of the CU and the chroma components may be expressed either within U and V components or Cr and Cb components of the CU. The luma component is understood to include some number of luma samples and each chroma component is understood to include some number of chroma samples. Generally, the luma samples provide measures of brightness throughout a subject CU and thus represents the structural qualities of the video content of the subject CU, whereas the chroma samples provide measures of color throughout the subject CU. Because of this, conventional video compression schemes often use finer prediction approaches for predicting luma components of CUs than chroma components thereof. Such schemes may also use approaches directed to predicting those chroma components from the predicted luma components.

The process of video compression and decompression can introduce artifacts and distortions in the reconstructed video. To mitigate these issues, various filtering techniques are often employed during the decoding process. These filters aim to improve the visual quality of the reconstructed video, such as by smoothing out blocky artifacts, reducing noise, and enhancing details. Depending on the specific codec and configuration, zero or more filters may be applied to a reconstructed block. These filters may be referred to as post-reconstruction filters, which may or may not be in-loop filters. One such filter, known as a Cross-Component Sample Offset (CCSO) filter, leverages the correlation between different color components (luma and chroma) to enhance the visual quality of the reconstructed video. Another such filter, known as Constrained Directional Enhancement Filter (CDEF), identifies the direction of each block and then filters while controlling the filter strength along the direction and across it.

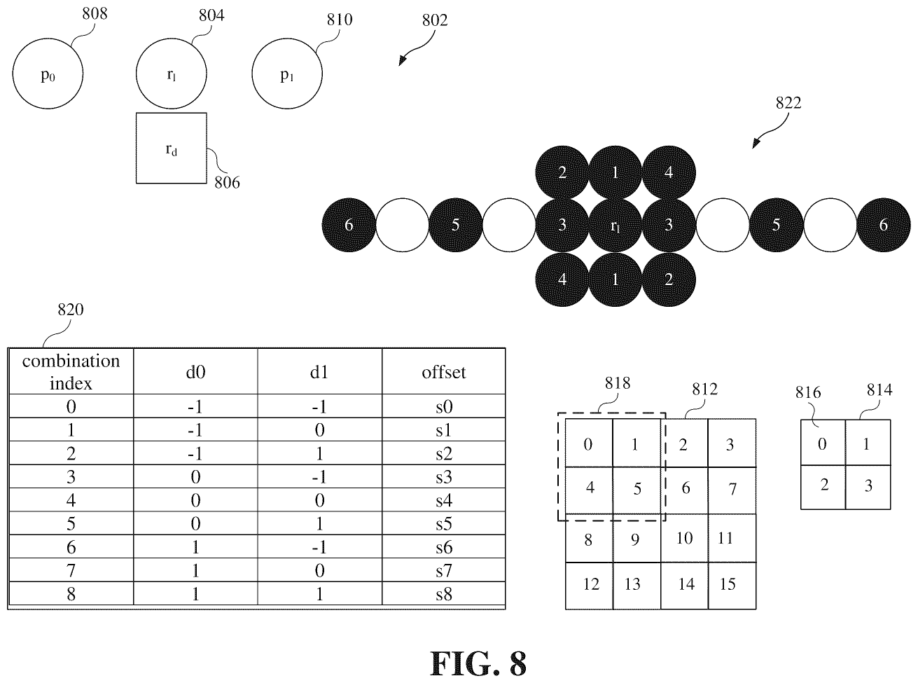

Briefly, the CCSO filter operates by adjusting at least one of luma or chroma samples based on the characteristics of corresponding and neighboring samples. CCSO utilizes a lookup table (LUT) that maps quantized differences between neighboring samples to offset values applied to current samples. The offset values are determined by the encoder and transmitted to the decoder. The encoder determines these offset values based on the source video data. The CCSO filter is further described with respect to FIG. 8.

The behavior of the CCSO filter and the CDEF can be controlled through various syntax elements signaled by an encoded to a decoder in a compressed video stream. These syntax elements may be signaled at the frame level and the block level. Syntax elements signaled at the frame level may provide information about the post-reconstruction filter for the entire frame. At the frame level, the signaling cost is relatively high, especially for cases with a high quantization parameter (QP). Accordingly, to increase the number of frames that can take advantage of a post-reconstruction filter, an option for the current frame to reuse (e.g., parameters within) the frame-level syntax from a previous frame may be signaled in the frame-level syntax. Additionally, an option for the current frame to reuse (e.g., on/off flags within) the block-level syntax for co-located blocks from the previous frame may be signaled in the frame-level syntax.

If a post-reconstruction filter is enabled for the current frame, but the frame-level syntax for a previous frame is not reused for the current frame, the remaining frame-level syntax elements for the post-reconstruction filter may be signaled for the current frame. Alternatively, if the post-reconstruction filter is enabled for the current frame and the frame-level syntax for a previous frame is reused for the current frame, the post-reconstruction filtering may be performed without signaling the remaining frame-level syntax elements. Accordingly, allowing the current frame to reuse the frame-level syntax for a previous frame reduces the header cost and may allow more frames to take advantage of post-reconstruction filtering.

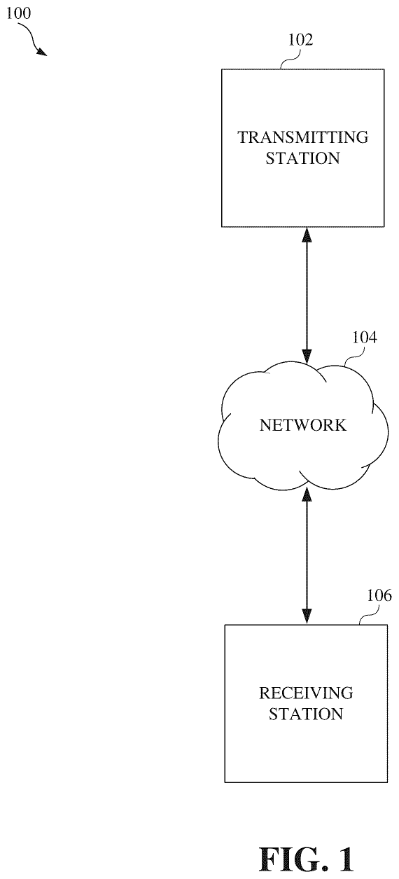

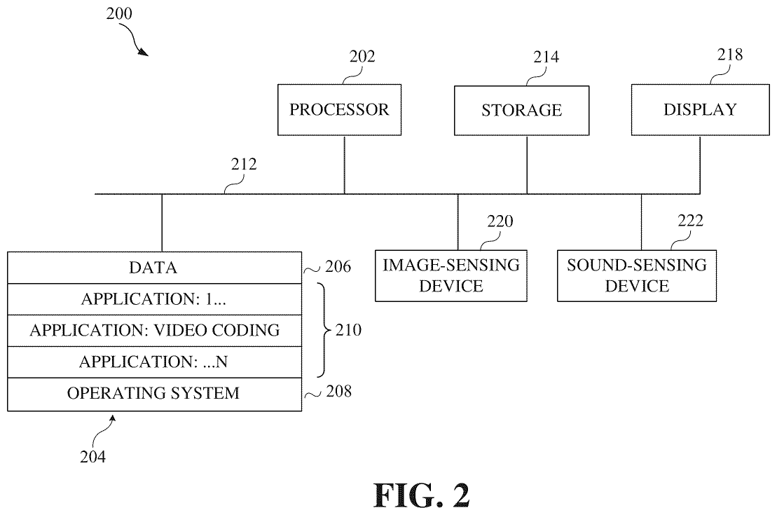

Further details of techniques for post-reconstruction filtering syntax prediction are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

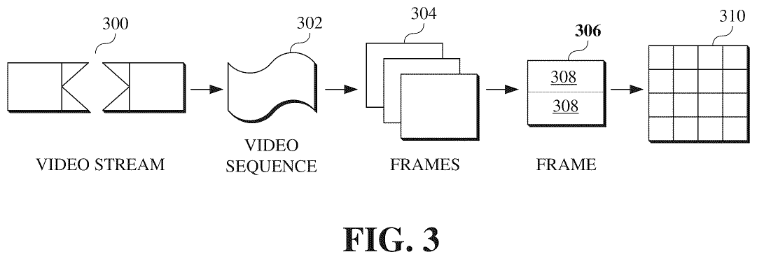

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance component and two chrominance components. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

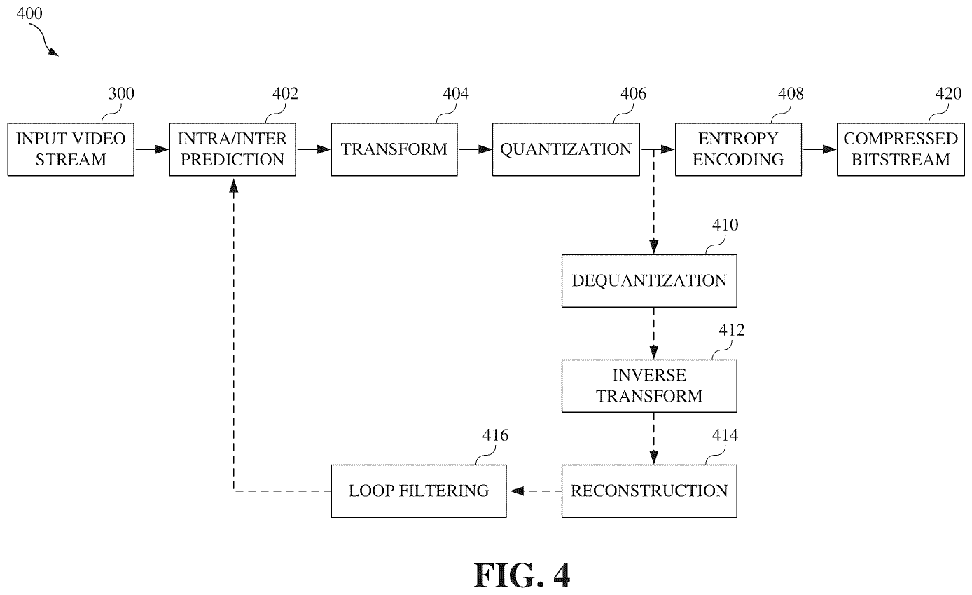

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

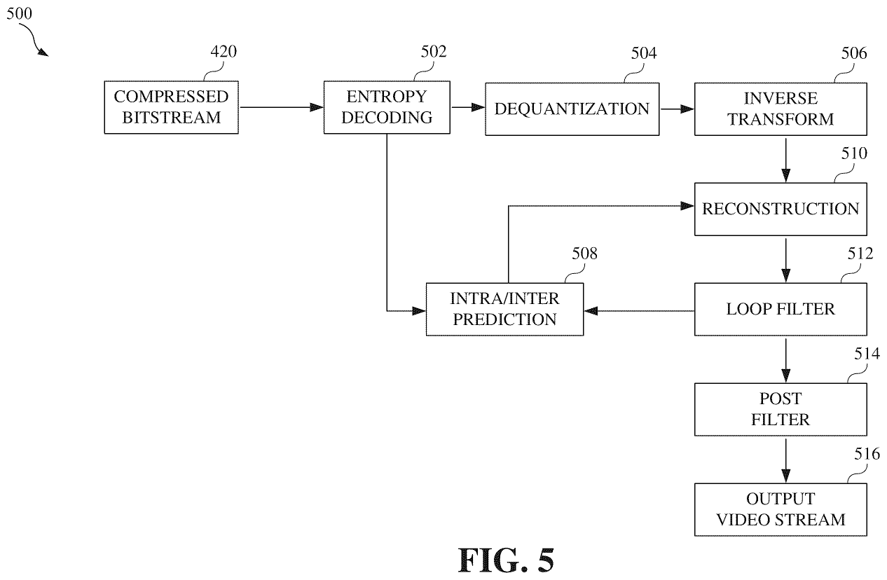

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

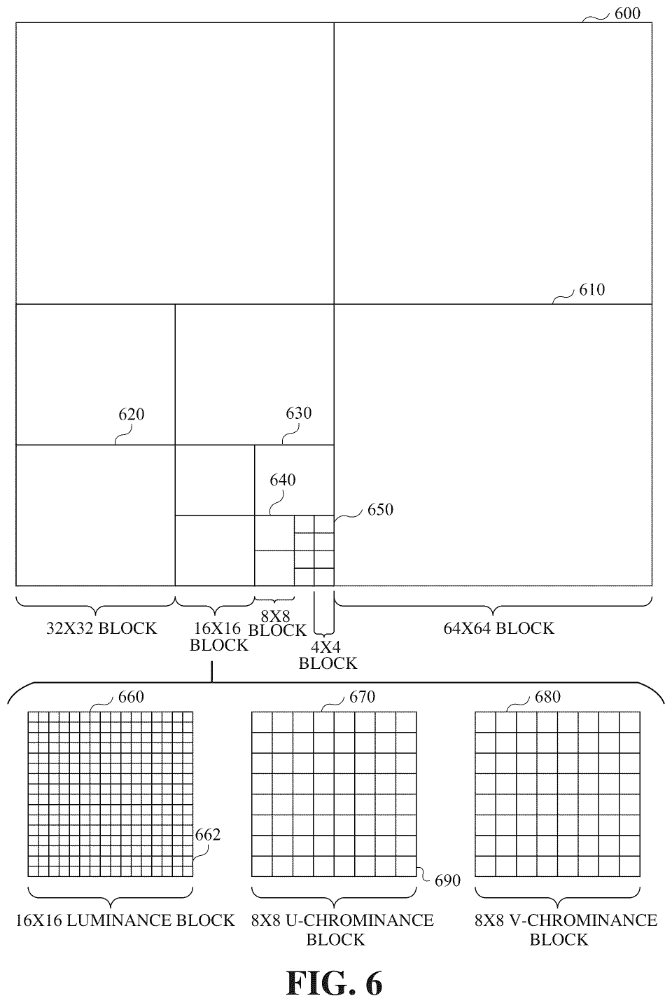

FIG. 6 is an illustration of examples of portions of a video frame 600, which may, for example, be the frame 306 shown in FIG. 3. The video frame 600 includes a number of 64×64 CTUs, such as four 64×64 CTUs 610 in two rows and two columns in a matrix or Cartesian component, as shown. Each 64×64 CTU 610 may include up to four 32×32 CUs 620. Each 32×32 CU 620 may include up to four 16×16 CUs 630. Each 16×16 CU 630 may include up to four 8×8 CUs 640. Each 8×8 CU 640 may include up to four 4×4 CUs 650. Each 4×4 CU 650 may include 16 pixels, which may be represented in four rows and four columns in each respective CU in the Cartesian plane or matrix.

In some implementations, the video frame 600 may include CTUs larger than 64×64 and/or CUs smaller than 4×4. Subject to features within the video frame 600 and/or other criteria, the video frame 600 may be partitioned into various arrangements. Although one arrangement of CUs is shown, any arrangement may be used. Although FIG. 6 shows N×N CTUs and CUs, in some implementations, N×M CTUs and/or CUs may be used, wherein N and M are different numbers. For example, 32×64 CTUs, 64×32 CTUs, 16×32 CUs, 32×16 CUs, or any other size may be used. In some implementations, N×2N CTUs or CUS, 2N×N CTUs or CUs, or a combination thereof, may be used.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown.

In some implementations, coding the video frame 600 may include ordered block-level coding. Ordered block-level coding may include coding CUs of the video frame 600 in an order, such as raster-scan order, wherein CUs may be identified and processed starting with a CTU in the upper left corner of the video frame 600, or portion of the video frame 600, and proceeding along rows from left to right and from the top row to the bottom row, identifying each CU in turn for processing. For example, the 64×64 CTU in the top row and left column of the video frame 600 may be the first CTU coded and the 64×64 CTU immediately to the right of the first CTU may be the second CTU coded. The second row from the top may be the second row coded, such that the 64×64 CTU in the left column of the second row may be coded after the 64×64 CTU in the rightmost column of the first row.

In some implementations, coding a CTU of the video frame 600 may include using quad-tree coding, which may include coding smaller CUs within a CTU in raster-scan order. For example, the 64×64 CTU shown in the bottom left corner of the portion of the video frame 600 may be coded using quad-tree coding wherein the top left 32×32 CU may be coded, then the top right 32×32 CU may be coded, then the bottom left 32×32 CU may be coded, and then the bottom right 32×32 CU may be coded. Each 32×32 CU may be coded using quad-tree coding wherein the top left 16×16 CU may be coded, then the top right 16×16 CU may be coded, then the bottom left 16×16 CU may be coded, and then the bottom right 16×16 CU may be coded. Each 16×16 CU may be coded using quad-tree coding wherein the top left 8×8 CU may be coded, then the top right 8×8 CU may be coded, then the bottom left 8×8 CU may be coded, and then the bottom right 8×8 CU may be coded. Each 8×8 CU may be coded using quad-tree coding wherein the top left 4×4 CU may be coded, then the top right 4×4 CU may be coded, then the bottom left 4×4 CU may be coded, and then the bottom right 4×4 CU may be coded. In some implementations, 8×8 CUs may be omitted for a 16×16 CU, and the 16×16 CU may be coded using quad-tree coding wherein the top left 4×4 CU may be coded, then the other 4×4 CUs in the 16×16 CU may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of luma samples, and by two lower resolution chrominance components, each of which represents the portion of the image as an 8×8 block of chroma samples. A sample may indicate a value, for example, a value in the range from 0 to 255, and may be stored or transmitted using, for example, eight bits. Although this disclosure is described in reference to the YUV color model, another color model may be used. Reducing spatial redundancy may include transforming a CU into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values and/or luma and chroma samples may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

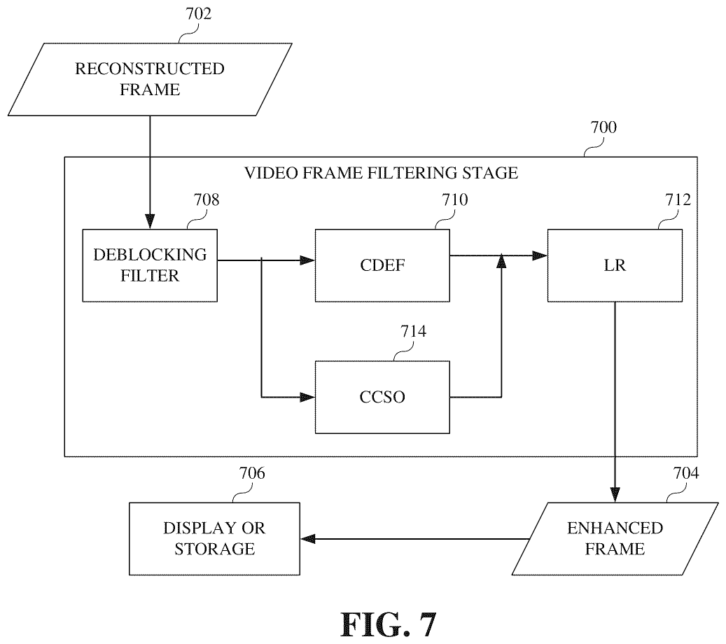

FIG. 7 is a block diagram of an example apparatus of a video frame filtering stage 700. The video frame filtering stage 700 performs filtering on a reconstructed frame 702 to obtain an enhanced frame 704 to prepare the reconstructed frame 702 for display or storage. During encoding, the video frame filtering stage 700 may be the loop filtering stage 416 of the encoder 400 shown in FIG. 4 or a stage that performs some, but not all, of the operations performed by the loop filtering stage 416. During decoding, the video frame filtering stage 700 may be the loop filtering stage 512 of the decoder 500 shown in FIG. 5 or a stage that performs some, but not all, of the operations performed by the loop filtering stage 512.

The reconstructed frame 702 is a video frame output from a reconstruction stage, which may be the reconstruction stage 414 of the encoder 400 or the reconstruction stage 510 of the decoder 500. After the filtering performed by the video frame filtering stage 700, the enhanced frame 704 is sent as output for display or storage 706. The display or storage 706 may represent or include operations for storing the enhanced frame 704 in a reference frame buffer of the encoder 400 or of the decoder 500. Alternatively or additionally, the display or storage 706 may represent or include operations for outputting the enhanced frame 704 within an output video stream for display at a device that receives the output video stream.

The video frame filtering stage 700 receives the reconstructed frame 702 after the video frame is output from the reconstruction stage and prepares the reconstructed frame 702 for sending as output for the display or storage 706. The video frame filtering stage 700 may apply one or more filters to the reconstructed frame 702 to obtain the enhanced frame 704. The encoder selects and signals in the compressed bitstream which of the available filters are to be applied to the reconstructed frame 702. The encoder can encode (e.g., signal) parameters (e.g., configuration characteristics) for the filters. In an example, a deblocking filter 708 is always applied and, as such, the encoder does not signal whether the deblocking filter 708 is to be applied.

The video frame filtering stage 700 uses processing units to process individual regions of the reconstructed frame 702 one at a time. A processing unit is a coding structure of size M×N, where M and N may be the same or different numbers. The size of the processing units may be based on the size of the largest block within the reconstructed frame 702. For example, if the largest block within the reconstructed frame 702 is 128×128, the processing units used by the video frame filtering stage 700 may be of size 128×128 or larger. In an example, each filter of the video frame filtering stage 700 may use different processing unit sizes.

The processing units are typically square in shape. However, as the processing units may be of size M×N, the processing units may be square or rectangular in shape. The processing units are typically all of the same size and shape. However, in some cases, the processing units may be variably sized and/or variably shaped. For example, a variable size and/or variable shape processing unit partitioning scheme can be used to divide the reconstructed frame 702 into a plurality of processing units.

Each of the processing units includes pixel values from a region of the reconstructed frame 702. Each of the pixel values of the video frame is included in a single processing unit. As such, the video frame filtering stage 700 filters each of the pixel values of the reconstructed frame 702 by processing each of the processing units. The video frame filtering stage 700 sequentially processes the processing units one at a time. The order for processing the processing units at the video frame filtering stage 700 may depend upon a scan order or other order for the encoding or decoding of the reconstructed frame 702. For example, where a raster order is used, the video frame filtering stage 700 first processes a processing unit that includes top-left-most pixel values of the reconstructed frame 702.

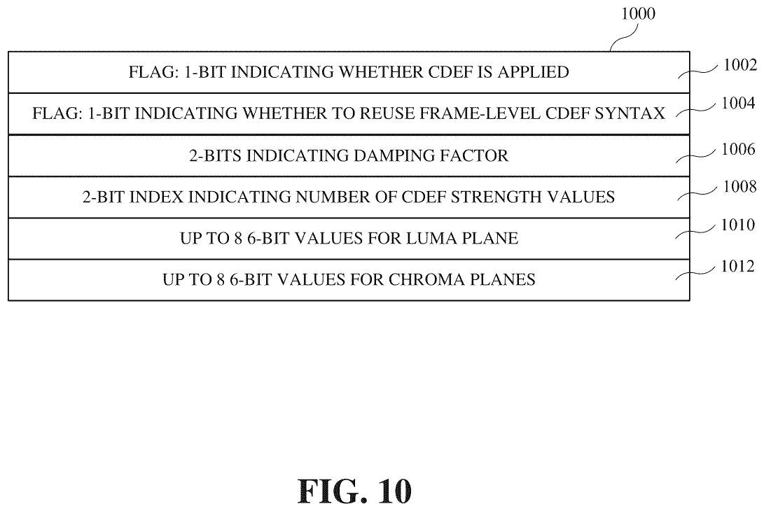

The video frame filtering stage 700 is shown as including the deblocking filter 708, a constrained directional enhancement filter (CDEF) 710, a loop restoration (LR) filter 712, and a CCSO filter 712. The video frame filtering stage 700 may include more or fewer filters. The CCSO filter 714 can be performed in parallel with the CDEF 710. That is, the input to the CCSO filter 714 is the same as that provided to the CDEF 710 and the output is applied to the CDEF-filtered samples (e.g., the output of each filter may be combined). The CCSO filter 714 is further described with respect to FIG. 8, and the CDEF filter is further described with respect to FIG. 10.

The deblocking filter 708 can be applied across transform block boundaries to remove block artifacts caused by quantization errors. The CDEF 710 performs edge direction searching at an 8×8 block-level. In CDEF, eight edge directions can be identified within blocks according to edge templates. A primary filter processes reconstruction samples along the edge direction while a secondary filter processes reconstruction samples along a direction 45-degrees from the edge direction.

The LR filter 712 is applied to units of either 64×64-pixel, 128×128-pixel, or 256×256-pixel blocks, named loop restoration units (LRU). Bypass filtering, a Wiener filter, or a self-guided filter can be independently selected for each LRU. The self-guided filter scheme applies simple filters to reconstructed pixels, X, to generate two denoised versions, X₁ and X₂; their differences from the reconstructed pixels, (X₁-X) and (X₂-X), are used to span a sub-space, upon which the differences between the reconstructed pixels and the original pixels, (Xₛ-X) are projected.

The Wiener filter can be a 7×7 separable filter that includes a 7-tap vertical filter and a 7-tap horizontal filter. Filtering of the reconstruction samples of a block can be performed by applying the vertical and horizontal filters sequentially. After applying the vertical and horizontal filters, the final filtered reconstruction samples are generated. The decoded frame pixel values (at (p, q) and a k×k neighbourhood of the pixel) are used to filter to obtain a filtered frame value at corresponding pixels. The process can be formulated as shown in equation (1).

$$\hat{x} ( p , q ) = {\sum }_{m , n = - \frac{k}{2}}^{\frac{k + 1}{2} - 1} x ( p + m , q + n ) * {f}^{( p , q )} ( m , n ) \qquad ( 1 )$$

In equation (1), (p, q) indicates a location of a pixel of an image or video frame, and f^{(p,q)}(m, n) are the filter coefficients for its k×k neighbourhood. The filter coefficients can be derived by an encoder and signalled into a compressed bitstream. Alternatively, a set of filters may be pre-defined and stored at both an encoder and a decoder, and a predefined logic can be used to select the filter for a pixel or block at both the encoder and the decoder. Some other shape of the neighborhood, such as a diamond shape, may be used instead of the rectangle or square (i.e., k×k) shape.

In some implementations, symmetric Wiener filters can be used to reduce the bit overhead associated with filter coefficient signaling as well as to reduce the computational complexity of the filtering process. As such, only three coefficients need to be signaled for a 7-tap filter, with the three mirrored coefficients derived as the same values. That is, in the symmetric filter, the value of f^{(p,q)}(m, n) is equal to f^{(p,q)}(−m,−n).

As mentioned briefly above, a CCSO filter (e.g., its behavior) can be controlled through various syntax elements signaled by an encoder to a decoder in a compressed video bitstream. Among these elements are block-level control flags, which direct the decoder on whether to apply the CCSO filter to a specific color component (i.e., color plane) of a block. A block-level control flag associated with a color component is used by the decoder to determine whether the CCSO filter should be applied to that color component of the particular block. The block-level control flags are applied at the CCSO unit level. A reconstructed frame is partitioned into CCSO units (i.e., filter processing units), and the application of the CCSO filter to a CCSO unit is determined by the corresponding block-level control flag. The size of a CCSO unit can be that of the largest coding block, which may also be referred to as a macroblock or superblock. For some codecs, the largest coding block size can be 256×256 pixels for a luma block or 128×128 pixels for a corresponding chroma block; however, other sizes for the CCSO unit are possible.

FIG. 8 is a block diagram that illustrates the operations of the CCSO filter. The CCSO filter may adjust reconstructed samples of a video frame to enhance the visual quality of the reconstructed video frame, such as the reconstructed frame 702 of FIG. 7. The CCSO filter corrects luma and/or co-located chroma reconstruction samples with offsets. The CCSO filter operates on CCSO units (also referred to herein as “block”) of the reconstructed video frame. As mentioned above, a CCSO unit can have the size of the largest possible coding block size.

A filter 802 illustrates that the CCSO filter uses a 3-tap filter applied to luma pixels. The CCSO filter may be applied to either or both of the luma or chroma pixels of a current block. In CCSO, a set of 3-tap filters are used. The input luma reconstructed samples located at the three filter taps include a current luma pixel 804 (i.e., denoted r₁) in the center, and two symmetrically neighboring luma samples 808 and 810, denoted p₀ and p₁, respectively. In this context, the current luma pixel 804 has a co-located chroma pixel 806, denoted r_{d}. When the CCSO filter is applied to a luma sample, the current luma pixel 804 is an actual luma sample of reconstructed video frame; and when the CCSO filter is applied to a chroma sample, the current luma pixel 804 is a co-located luma pixel to a chroma sample. The co-located luma pixel may be obtained as described herein and may be, in some implementations, an actual luma sample of reconstructed video frame.

To illustrate the concept of a luma pixel being co-located with a chroma pixel, a 4:2:0 chroma subsampling scheme is assumed. In this scheme, each chroma pixel corresponds to four luma pixels. For example, a luma block 812 corresponds to a chroma block 814. In this scheme, each group of four luma pixels in the luma block 812 (e.g., luma pixels 818 numbered 0, 1, 4, and 5) corresponds to one chroma pixel (e.g., chroma pixel 816 numbered 0) in the chroma block 814. The luma co-located pixel for the chroma pixel 816 can be derived from the corresponding luma pixels 818. The co-located luma pixel may be the average, the median, or some other function of the luma pixels 818. The co-located luma pixel may be one of the luma pixels 818, such as the top-left luma pixel (e.g., the luma pixel numbered 0). Other ways of obtaining the co-located luma pixel are also possible.

The differences between these luma samples used in the filtering are computed, and these differences are quantized into discrete levels denoted as d₀ and d₁. The quantized values are then used to determine a combination index from a combination lookup table (LUT) 820.

That is, given pᵢ and rl, where i=0, 1, the following steps are applied to process the input samples:
1) the delta values, denoted mᵢ, between pᵢ and rₗ are computed (i.e., mᵢ=rₗ−pᵢ), then
2) the delta values, mᵢ, are quantized as dᵢ based on a quantization step size Q_{CCSO}, using the following quantization process:
   a) dᵢ is set equal to −1, if mᵢ is less than −Q_{CCSO},
   b) dᵢ is set equal to 0, if mᵢ is in the range [−Q_{CCSO}, Q_{CCSO}], and
   c) dᵢ is set equal to 1, if mᵢ is greater than Q_{CCSO}.

The quantization step size, Q_{CCSO}, can be 8, 16, 32, or 64. After d₀ and d₁ are calculated, an offset value (denoted s) is derived using the LUT 820. Each combination of d₀ and d₁ is used to identify a row in the LUT 820 to retrieve the offset value, namely a gradient offset. The offset values can be integers including 0, 1, −1, 3, −3, 7, −7, and −10. Finally, the derived offset s of CCSO is applied on chroma color component using equation (2).

$${r}_{c}^{′} = clip ( {r}_{c} + s ) \qquad ( 2 )$$

In equation (2), r_{c} is the reconstructed sample to be filtered by CCSO, and s is the derived offset value retrieved from the LUT 820, the filtered sample value r_{c}′ is further clipped into the range specified by the bit depth.

The same CCSO process can be applied to the luma components with the exception that the output is applied on the luma reconstruction samples themselves and a co-located luma pixel need not be used (e.g., calculated, selected, etc.).

In CCSO, there are six optional filter shapes, denoted as fᵢ, i=1 . . . 6, as shown in filters 822. These six filter shapes are switchable (e.g., selectable or set) at video frame level, and the selection can be signaled by a syntax element, ext_filter_support, using a 3-bit fixed length code.

With respect to the LUT 820, the offset values so through s₈ may not be fixed and may vary from video frame to video frame. As such, the offset values s₀ through s₈ can be calculated by an encoder and transmitted to the decoder in the compressed bitstream. The offset values s₀ through s₈ can be transmitted as nine, 3-bit offset values.

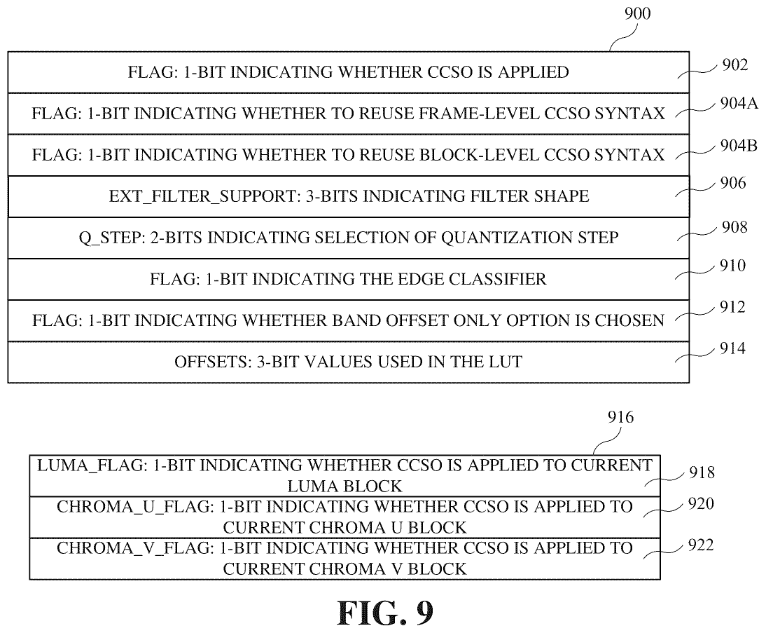

FIG. 9 illustrates syntax elements that may be used to signal aspects of the CCSO filter. The signaling of CCSO can be categorized into frame-level and block-level syntax elements. A table 900 illustrates the frame-level syntax elements; and a table 916 illustrates the block-level syntax elements. In this context, a “block” refers to a CCSO unit (e.g., the largest coding block size). For example, with respect to a luma block, the block (e.g., the CCSO unit) may be 256×256 pixels, and the corresponding chroma blocks (CCSO units) may each be 128×128 pixels in a 4:2:0 subsampling format. The block-level flags enable CCSO to be selectively applied within these blocks, depending on the content and the desired level of filtering.

The table 900 is shown as including syntax elements 902 through 914. The syntax elements of the table 900 can be included in a compressed bitstream of frame header for each color component of a video frame. For purposes of this description, the syntax elements of the table 900 are described with respect to the luma component. The syntax element 902 (e.g., FLAG) is a one-bit flag indicating whether CCSO is applied (e.g., enabled) for the luma component of the frame. That is, the syntax element 902 indicates whether the CCSO filter is applied to at least one luma block to the frame. If CCSO is not enabled for the luma component of the frame, then the other syntax elements (e.g., the syntax elements 904A through 914) are not included in the compressed bitstream.

The syntax element 904A (e.g., FLAG) is a one-bit flag indicating whether to reuse the following frame-level syntax elements (e.g., the syntax elements 906 through 914) from a previous frame. If the syntax elements are reused, then the following syntax elements (e.g., the syntax elements 906 through 914) are not included in the compressed bitstream. The previous frame may be a most-recently coded (i.e., encoded or decoded) frame. Alternatively, the previous frame may be a specific previously coded frame, for example the previous frame having a quantization parameter closest to a quantization parameter of the frame. The frame header may include a designation of the specific previously coded frame, such as a 3-bit index of the previously coded frame within a reference frame list. This 3-bit index, when used, can be located after syntax element 904A or after syntax elements 904A and 904B and before syntax element 906, where present.

The syntax element 904B (e.g., FLAG2) is a one-bit flag indicating whether to reuse the block-level syntax elements from a previous frame. If the syntax elements are reused, then the block-level (e.g., on/off syntax elements) are not included in the compressed bitstream. The previous frame may be a most-recently coded (i.e., encoded or decoded) frame. Alternatively, the previous frame may be a specific previously coded frame, for example the previous frame having a quantization parameter closest to a quantization parameter of the frame. The frame header may include a designation of the specific previously coded frame, such as a 3-bit index of the previously coded frame within a reference frame list. The syntax element 904B may be included after the frame-level syntax elements (e.g., after the syntax elements 906 through 914).

As discussed in more detail below, the syntax elements 904A and 904B may be used separately or together. That is, when a post-reconstruction filter, such as a CCSO filter, uses both frame-level and block-level filtering, either or both of the syntax elements 904A and 904B may be used.

The syntax element 906 (e.g., EXT_FILTER_SUPPORT) is a three-bit field indicating the filter shape to be used during the CCSO process. The filter shapes can be as described with respect to FIG. 8. The syntax element 908 (e.g., Q_STEP) is a two-bit field indicating the selection of the quantization step (e.g., Q_{CCSO} described above). This field defines the level of quantization applied to the calculated differences, m_{i}, which in turn affects the offsets used in the CCSO process. Syntax element 910 (e.g., FLAG) is a one-bit flag indicating the edge classifier. Syntax element 912 (e.g., FLAG) is a one-bit flag indicating whether the band offset only option is chosen. Syntax elements 914 (e.g., OFFSETS) includes nine three-bit values that are used in the LUT (e.g., the LUT 820 of FIG. 8) for determining the offset values applied during the CCSO process. The syntax elements 914 may include up to 72 three-bit offset values when the band offset only option is not chosen, and the syntax elements 914 may include up to 128 three-bit offset values when the band offset only option is chosen.

Again, the frame-level syntax elements 902 through 914 may be included in the frame header for each of the Y (luma), U (chroma U), and V (chroma V) color components. In some implementations, the U and V syntax elements may be assumed to be the same, allowing for a more efficient bitstream. That is, the frame header would not include separate syntax elements for the chroma U and chroma V color components-only one set of syntax elements would be signaled for both.

The table 916 is shown as including flags 918 through 922. The flag 918 (e.g., LUMA_FLAG) is a one-bit flag indicating whether CCSO is applied to the current luma block (the current CCSO unit). This flag provides fine control at the block level, enabling or disabling CCSO for specific luma blocks within the frame. The flag 920 (e.g., CHROMA_U_FLAG) is a one-bit flag indicating whether CCSO is applied to the current chroma U block. Similar to the luma flag, this flag allows selective application of CCSO to chroma U blocks. The flag 922 (e.g., CHROMA_V_FLAG) is a one-bit flag indicating whether CCSO is applied to the current chroma V block. This flag enables or disables CCSO for specific chroma V blocks, allowing for precise control over the application of CCSO across different color components.

FIG. 10 illustrates syntax elements that may be used to signal aspects of the CDEF. The signaling of CDEF can be categorized into frame-level and block-level syntax elements. A table 1000 illustrates the frame-level syntax elements. An illustration of the block-level syntax elements for the CDEF is omitted but may be similar to the block-level syntax elements for the CCSO filter illustrated in FIG. 9. The block-level flags define an index (0 to 3 bits) that depends on the number of CDEF strength values in bits.

The CDEF is a post-reconstruction filter designed to filter out coding artifacts while retaining details of an image. CDEF operates by identifying the direction of each block before adaptively filtering along the identified direction and filtering to a lesser degree along directions rotated 45 degrees compared to the identified direction. The CDEF is parameterized by a strength and a damping provided to the filter.

The table 1000 is shown as including syntax elements 1002 through 1012. The syntax elements of the table 1000 can be included in a compressed bitstream of frame header for the color components of a video frame. The syntax element 1002 (e.g., FLAG) is a one-bit flag indicating whether CDEF is applied (e.g., enabled) for the color components of the frame. That is, the syntax element 1002 indicates whether the CDEF filter is applied to at least one block of the frame. If CDEF is not enabled for the frame, then the other syntax elements (e.g., the syntax elements 1004 through 1012) are not included in the compressed bitstream.

The syntax element 1004 (e.g., FLAG) is a one-bit flag indicating whether to reuse the following frame-level syntax elements (e.g., the syntax elements 1006 through 1012) from a previous frame. If the syntax elements are reused, then the following syntax elements (e.g., the syntax elements 1006 through 1012) are not included in the compressed bitstream. The previous frame may be a most-recently coded (i.e., encoded or decoded) frame. Alternatively, the previous frame may be a specific previously coded frame, for example, the previous frame may be a coded frame before the current frame having a quantization parameter closest to a quantization parameter of the current frame. The frame header may include a designation of the specific previously coded frame, such as a 3-bit index identifying a reference frame from a reference frame list, following syntax element 1004.

The syntax element 1006 may be two bits indicating a damping factor of the CDEF. The syntax element 1008 may be a two-bit index indicating a number of CDEF strength values. Syntax elements 1010 include up to eight six-bit values. Syntax elements 1012 include up to eight six-bit values for the chroma planes.

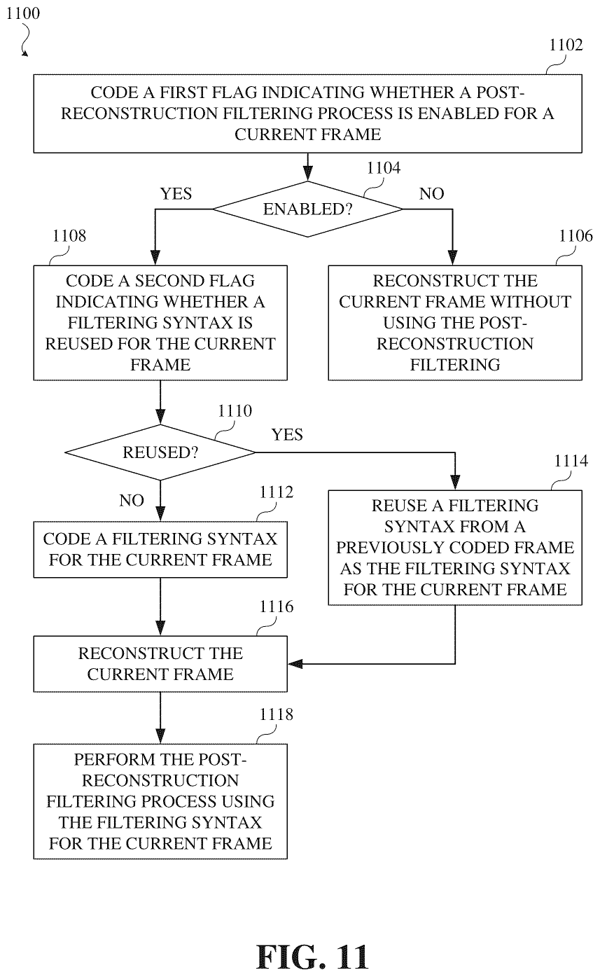

FIG. 11 is a flowchart of a technique 1100 for predicting the syntax for a post-reconstruction filtering process. The post-reconstruction filtering process may include a CCSO filtering process, a CDEF filtering process, another type of post-reconstruction filtering, or any combination. The technique 1100 may be implemented, for example, as a software program that may be executed by computing devices such as the transmitting station 102 or the receiving station 106. The software program can include machine-readable instructions that may be stored in a memory such as the memory 204 or the secondary storage 214, and that, when executed by a processor, such as the processor 202, may cause the computing device to perform the technique 1100. The technique 1100 may be implemented using specialized hardware or firmware. Multiple processors, memories, or both, may be used. The technique 1100 may be implemented by an encoder, such as the encoder 400, or a decoder, such as the decoder 500. Coding and its variations, as used herein, may include encoding, decoding, or some combination thereof, which will be clear from context.

At 1102, a first flag indicating whether a post-reconstruction filtering process is enabled for a current frame is coded. For example, the first flag may be the syntax element 902 indicating whether CCSO filtering is applied to (e.g., enabled for) the current frame. In another example, the first flag may be the syntax element 1002 indicating whether the CDEF is applied to (e.g., enabled for) the current frame. The first flag may be a one-bit flag that enables the post-reconstruction filtering process for the current frame if the first flag is true (e.g., 1) and disables the post-reconstruction filtering process for the current frame if the first flag is false (e.g., 0).

At 1104, the technique 1100 determines if the post-reconstruction filtering process is enabled (e.g., true or false) for the current frame based on the first flag coded at 1102. If the post-reconstruction filtering process is not enabled at 1104, the technique 1100 proceeds to 1106. At 1106, the technique 1100 reconstructs the current frame without using the post-reconstruction filtering (i.e., the post-reconstruction filtering process is not applied to the current frame after reconstruction).

If the post-reconstruction filtering process is enabled at 1104 (e.g., in response to determining that the post-reconstruction filtering process is performed for the current frame), the technique 1100 proceeds to 1108. At 1108, a second flag indicating whether a filtering syntax is reused for the current frame is coded. The reused filtering syntax may be a frame-level or block-level filtering syntax for a previously coded frame. For example, the second flag may be the syntax element 904A indicating whether to reuse the frame-level CCSO syntax from a previously coded frame or may be the syntax element 904B indicating whether to reuse the block-level CCSO syntax from a previously coded frame. In another example, the second flag may be the syntax element 1004 indicating whether to reuse the frame-level CDEF syntax from a previously coded frame. The second flag may be a one-bit flag that reuses the filtering syntax from the previously coded frame for the current frame (i.e., omits following syntax elements) if the second flag is true (e.g., 1) and does not reuse the filtering syntax (i.e., codes the following syntax elements) if the second flag is false (e.g., 0).

At 1110, the technique 1100 determines if the filtering syntax from the previously coded frame is reused as the filtering syntax for the current frame. If the filtering syntax from the previously coded frame is not reused, the technique 1100 proceeds to 1112. At 1112, the technique 1100 codes a filtering syntax for the current frame. Coding the filtering syntax for the current frame may include encoding or decoding a frame-level or a block-level filtering syntax to/from an encoded bitstream. For example, coding the filtering syntax for the current frame may include coding the syntax elements 906 through 914 for use in a CCSO filter. In another example, coding the filtering syntax for the current frame may include coding the syntax elements 1006 through 1012 for use in a CDEF. The filtering syntax coded for the current frame at 1112 may be reused by a future frame applying the technique 1100.

If the filtering syntax from the previously coded frame is reused (e.g., in response to determining that the filtering syntax is reused), the technique 1100 proceeds to 1114. At 1114, the filtering syntax from the previously coded frame is reused as the filtering syntax for the current frame. For example, reusing the filtering syntax from the previously coded frame may include omitting the syntax elements 906 through 914 for the current frame and instead reusing the syntax elements 906 through 914 from the previously coded frame or omitting the syntax elements (or flags) 918 through 922 for the current frame and instead reusing the syntax elements (or flags) 918 through 922 from the previously coded frame for the CCSO filter. In another example, reusing the filtering syntax from the previously coded frame may include omitting the syntax elements 1006 through 1012 for the current frame and instead reusing the syntax elements 1006 through 1012 from the previously coded frame for the CDEF. The previously coded frame may be a most-recently coded frame. Alternatively, the previously coded frame may be a specific previously coded frame. The frame header may include a designation of the specific previously coded frame. For example, a 3-bit reference frame index may be coded (encoded or decoded) between 1110 and 1114.

The technique 1100 then proceeds to 1116, that is, the technique 1100 proceeds from either 1112 to 1116 or from 1114 to 1116. At 1116, the technique 1100 reconstructs the current frame.

At 1118, the technique 1100 performs the post-reconstruction filtering process using the filtering syntax for the current frame. For example, the post-reconstruction filtering process is a CCSO filtering process. In another example, the post-reconstruction filtering process is a CDEF filtering process. The filtering syntax for the current frame may be determined at 1112 as new syntax elements coded for the current frame. Alternatively, the filtering syntax for the current frame may be determined at 1114 as a reused filtering syntax from a previously coded frame. For example, an index identifying the previously coded frame may be determined, the system may use a default previously coded frame, such as the last (e.g., most recent) coded frame, or comparison of the QP value for the current frame may be compared to multiple previously coded frames to identify the previously coded frame from which to obtain the filtering syntax.

At an encoder, the technique 1100 may decide whether to reuse the filtering syntax from a previously encoded frame at 1110 based on a rate-distortion error comparison. For example, the encoder may reconstruct the current frame and determine a first rate-distortion error value by performing the post-reconstruction filtering process on the reconstructed current frame using the filtering syntax for the current frame and comparing the filtered current frame (i.e., a first filtered frame) to the reconstructed frame. The encoder may determine a second rate-distortion error value by performing the post-reconstruction filtering process on the reconstructed current frame using the reused filtering syntax from the previously coded frame and comparing the filtered current frame (i.e., a second filtered frame) to the reconstructed frame. The first rate-distortion error and the second rate-distortion error may be compared to determine whether to reuse the filtering syntax from the previously encoded frame for the current frame. For example, if the first rate-distortion error is smaller, the technique 1100 may proceed to 1112 and encode the filtering syntax for the current frame. Alternatively, if the second rate-distortion error is smaller, the technique 1100 may proceed to 1114 and reuse the filtering syntax from the previously encoded frame as the filtering syntax for the current frame.

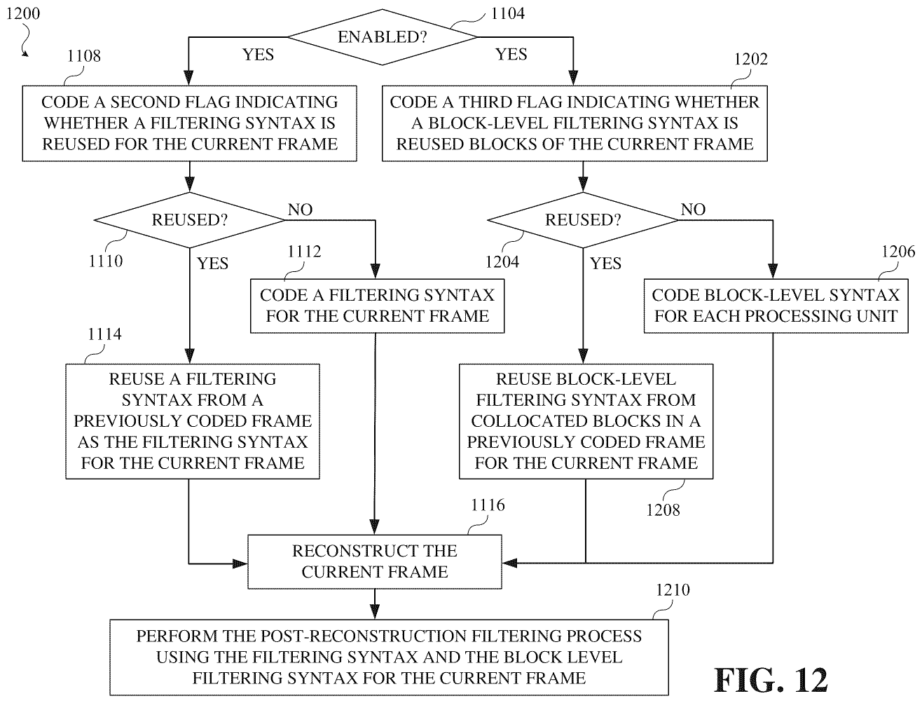

FIG. 12 is a flowchart of a technique 1200 for predicting block-level syntax for a post-reconstruction filtering process. The post-reconstruction filtering process may include a CCSO filtering process or any other type of post-reconstruction filtering process that uses both frame-level and block-level signaling. The technique 1200 may be implemented, for example, as a software program that may be executed by computing devices such as the transmitting station 102 or the receiving station 106. The software program can include machine-readable instructions that may be stored in a memory such as the memory 204 or the secondary storage 214, and that, when executed by a processor, such as the processor 202, may cause the computing device to perform the technique 1200. The technique 1200 may be implemented using specialized hardware or firmware. Multiple processors, memories, or both, may be used. The technique 1200 may be implemented by an encoder, such as the encoder 400, or a decoder, such as the decoder 500. Coding and its variations, as used herein, may include encoding, decoding, or some combination thereof, which will be clear from context.

The technique 1200 may be implemented as an alternative to the technique 1100 but shares several steps with the technique 1100 using the filtering syntax referenced therein as frame-level filtering syntax. Accordingly, a description of those steps is abbreviated below. Although not shown in FIG. 12, the technique may start by coding a first flag indicating whether a post-reconstructions filtering process is enabled for the current frame at 1102. If enabled at 1104, the technique 1200 can advance to both 1108 and 1202.

As described above with reference to FIG. 11, at 1108, a second flag indicating whether a filtering syntax is reused for the current frame is coded. More specifically, the second flag indicates whether a frame-level filtering syntax (e.g., frame level filtering parameters) is reused. The technique 1200 then proceeds to 1110 and determines if the filtering syntax from the previously coded frame is reused as the filtering syntax for the current frame. If the filtering syntax from the previously coded frame is not reused, the technique 1200 proceeds to 1112. At 1112, the technique 1200 codes a frame-level filtering syntax for the current frame. If the filtering syntax from the previously coded frame is reused, the technique 1200 proceeds to 1114. At 1114, the filtering syntax from the previously coded frame is reused as the frame-level filtering syntax for the current frame.

The technique 1200 also proceeds from 1104 to 1202. At 1202, a third flag indicating whether a block-level filtering syntax is reused for the current frame is coded. In the CCSO example of FIG. 9, the third flag is the syntax element 904B. The block-level filtering syntax may include flags, such as on/off flags, or other parameters, such as the table 916 for CCSO filtering. The reused block-level filtering syntax may be block-level filtering syntax for co-located blocks in a previously coded frame (i.e., respective blocks in the same spatial positions within their respective frame as the current frame). For example, the third flag may be included in a compressed bitstream of frame header for color components of a video frame. For example, the third flag may be included with the syntax elements in table 900 or any other post filtering frame level syntax that also uses block-level syntax for filtering. The third flag may be a one-bit flag that indicates to reuse the block-level filtering syntax from the previously coded frame for the current frame (e.g., omit block-level flags) if the third flag is true (e.g., 1) and indicates to not reuse the block-level filtering syntax (e.g., code the block-level flags) if the third flag is false (e.g., 0), or vice versa.

At 1204, the technique 1200 determines if the block-level filtering syntax from the previously coded frame is reused as the block-level filtering syntax for the current frame. If the block-level filtering syntax from the previously coded frame is not reused, the technique 1200 proceeds to 1206. At 1206, the technique 1200 codes block-level filtering syntax for each processing unit in the current frame. The processing unit may be, for example, a current CCSO unit. The processing unit may be a fixed size, for example, 128×128 pixels. Coding the block-level filtering syntax for the current frame may include encoding or decoding the block-level filtering syntax to/from an encoded bitstream. For example, coding the block-level filtering syntax may include coding the flags 918 through 922 shown in table 916 for use in a CCSO filter. The block-level filtering syntax coded for the current frame at 1206 may be reused by a future frame applying the technique 1200.

If the block-level filtering syntax from the previously coded frame is reused, the technique 1200 proceeds to 1208. At 1208, the block-level filtering syntax for blocks of the previously coded frame are reused as the block-level filtering syntax for blocks of the current frame. The block-level filtering syntax for respective blocks of the current frame may be reused from collocated blocks in the previously coded frame. For example, the values (i.e., on or off) of block-level flags for a previously coded collocated block may be used as the values for block-level flags for the current block. In an example, reusing the block-level filtering syntax from the previously coded frame may include omitting the flags 918 through 922 for blocks of the current frame and instead reusing the flags 918 through 922 from blocks of the previously coded frame for the CCSO filter. As described above, the previously coded frame may be a most-recently coded frame. Alternatively, the previously coded frame may be a specific previously coded frame. The frame header may include a designation of the specific previously coded frame, such as a 3-bit index into a reference frame list. For example, a 3-bit reference frame index may be coded (encoded or decoded) between 1110 and 1114 and/or between 1204 and 1208.

The technique 1200 then proceeds to 1116, that is, the technique 1200 proceeds either from 1112 to 1116 or from 1114 to 1116, and also proceeds either from 1206 to 1116 or from 1208 to 1116. The technique 1200 may perform 1108, 1110, and 1112 or 1114 before, concurrently, or after the technique 1200 performs 1202, 1204, and 1206 or 1208. At 1116, the technique 1200 reconstructs the current frame before proceeding to 1210.

At 1210, the technique 1200 performs the post-reconstruction filtering process using the frame level filtering syntax and, where used by the particular filtering process, the block-level filtering syntax for the current frame. The post-reconstruction filtering process performed at 1210 may be similar to the post-reconstruction filtering process performed at 1118 by technique 1100. For example, the post-reconstruction filtering process is a CCSO filtering process. The filtering syntax for the current frame may be determined at 1112 as new syntax elements coded for the current frame. Alternatively, the filtering syntax for the current frame may be determined at 1114 as reused filtering syntax from a previously coded frame. The block-level filtering syntax for the current frame may be determined at 1206 as new block-level filtering syntax coded for the current frame. Alternatively, the block-level flags for the current frame may be determined at 1208 as reused block-level filtering syntax from a previously coded frame.

The post-reconstruction filtering process performed at 1210 may use any combination of new and reused for the frame-level filtering syntax and block-level filtering syntax for the current frame. That is, both the filtering syntax and block-level filtering syntax for the current frame may be reused from a previously coded frame, one of the filtering syntax or the block-level filtering syntax for the current frame may be reused from a previously coded frame but not the other, or neither the filtering syntax nor the block-level filtering syntax may be reused from a previously coded frame. It is worth noting that, when frame-level and/or block-level filtering syntax is reused, the reference frame used at 1114 and 1208 for the filtering syntax at both the frame-level and the block-level for the current frame is most desirably the same frame. In such a way, the reference frame is determined only once. However, this is not necessary. When both frame-level and block-level filtering syntax is used, it is possible to use two different reference frames for the sources of filtering syntax.

At an encoder, the technique 1200 may decide whether to reuse the filtering syntax from a previously encoded frame at 1110 based on a rate-distortion error comparison as described above. A similar analysis may be made for deciding whether to reuse the block-level filtering syntax from a previously encoded frame at 1204. For example, the encoder may reconstruct the current frame and determine a first rate-distortion error value by performing the post-reconstruction filtering process on the reconstructed current frame using the block-level filtering syntax for blocks of the current frame and comparing the filtered current frame (i.e., a first filtered frame) to the reconstructed frame. The encoder may determine a second rate-distortion error value by performing the post-reconstruction filtering process on the reconstructed current frame using the reused block-level filtering syntax from blocks of the previously coded frame and comparing the filtered current frame (i.e., a second filtered frame) to the reconstructed frame. The first rate-distortion error and the second rate-distortion error may be compared to determine whether to reuse the block-level filtering syntax from the previously encoded frame for the current frame. For example, if the first rate-distortion error is smaller, the technique 1200 may proceed to 1206 and encode the block-level filtering syntax for the current frame. Alternatively, if the second rate-distortion error is smaller, the technique 1200 may proceed to 1208 and reuse the block-level filtering syntax from the previously encoded frame as the block-level flags for the current frame. Whether to reuse both the frame-level filtering syntax and the block-level filtering syntax may also be analyzed in this way.

For simplicity of explanation, the techniques herein are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a (e.g., non-transitory) computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. An apparatus, comprising:
a processor configured to:
decode, from a frame header of a current frame in an encoded bitstream, a first flag indicating whether a post-reconstruction filtering process is performed for the current frame;
in response to determining that the post-reconstruction filtering process is performed for the current frame, decode, from the encoded bitstream, a second flag indicating whether a post-reconstruction filtering syntax for the post-reconstruction filtering process of a previously decoded frame is reused for the current frame;
in response to determining that the post-reconstruction filtering syntax is reused:
use the post-reconstruction filtering syntax for the post-reconstruction filtering process of the previously decoded frame as the post-reconstruction filtering syntax of the current frame;
reconstruct the current frame; and
perform the post-reconstruction filtering process of the current frame after reconstruction using the post-reconstruction filtering syntax of the current frame.

2. The apparatus of claim 1, wherein the post-reconstruction filtering syntax comprises at least one of frame-level filtering syntax or block-level filtering syntax.

3. The apparatus of claim 1, wherein the post-reconstruction filtering syntax is a frame-level filtering syntax, and the processor is configured to:
decode, from the frame header of the current frame, a third flag indicating whether block-level filtering syntax for the post-reconstruction filtering process of the previously decoded frame is reused for blocks in the current frame; and
in response to determining that the block-level filtering syntax is reused:
use the block-level filtering syntax for the post-reconstruction filtering process of collocated blocks in the previously decoded frame as the block-level filtering syntax for each block in the current frame.

4. The apparatus of claim 1, wherein the post-reconstruction filtering syntax comprises at least one of frame-level filtering syntax or block-level filtering syntax, and the post-reconstruction filtering process is a Cross-Component Sample Offset (CCSO) filtering process.

5. The apparatus of claim 1, wherein the post-reconstruction filtering syntax comprises frame-level filtering syntax, and the post-reconstruction filtering process is a Constrained Directional Enhancement Filter (CDEF) filtering process.

6. The apparatus of claim 1, wherein the previously decoded frame is a most recently decoded frame before the current frame.

7. The apparatus of claim 1, wherein, in response to determining that the post-reconstruction filtering syntax is reused, the processor is configured to decode, from the encoded bitstream, an index identifying the previously decoded frame from a list of reference frames.

8. The apparatus of claim 1, wherein the previously decoded frame is a decoded frame before the current frame having a quantization parameter (QP) closest to a QP of the current frame.

9. A method, comprising:
decoding, from a frame header for a current frame in an encoded bitstream, a first flag indicating that a post-reconstruction filtering process is enabled for the current frame;
decoding, from the frame header, a second flag indicating to reuse a post-reconstruction filtering syntax used for the post-reconstruction filtering process of a previously decoded frame;
reconstructing a current frame; and
filtering a block of the current frame after reconstruction using the post-reconstruction filtering syntax.

10. The method of claim 9, wherein the post-reconstruction filtering syntax comprises at least one of frame-level filtering syntax or block-level filtering syntax.

11. The method of claim 9, wherein the post-reconstruction filtering syntax is a frame-level filtering syntax, and the method comprises:
decoding, from the frame header of the current frame, a third flag indicating that block-level filtering syntax for the post-reconstruction filtering process of the previously decoded frame is reused for blocks in the current frame; and
using the block-level filtering syntax for the post-reconstruction filtering process of collocated blocks in the previously decoded frame as the block-level filtering syntax for each block in the current frame.

12. The method of claim 11, wherein the post-reconstruction filtering process is a Cross-Component Sample Offset (CCSO) filtering process.

13. The method of claim 9, wherein the post-reconstruction filtering process is a Constrained Directional Enhancement Filter (CDEF) filtering process.

14. The method of claim 9, wherein the previously decoded frame is a most recently decoded frame before the current frame.

15. The method of claim 9, comprising:
decoding, from the encoded bitstream, an index identifying the previously decoded frame from a list of reference frames.

16. A non-transitory, computer-readable storage medium storing a compressed bitstream comprising encoded residual data corresponding to blocks of multiple frames of a video sequence, a first flag that indicates a post-reconstruction filtering process for a current frame is enabled, a second flag that indicates whether to reuse a post-reconstruction filtering syntax for a previously coded frame for the post-reconstruction filtering process for a current frame, and, where the second flag indicates to not reuse the post-reconstruction filtering syntax for the previously coded frame, a post-reconstruction filtering syntax for the post-reconstruction filtering process of the current frame after reconstruction.

17. The non-transitory, computer-readable storage medium of claim 16, wherein the compressed bitstream includes an identifier of the previously coded frame.

18. The non-transitory, computer-readable storage medium of claim 17, wherein the identifier comprises a 3-bit signal.

19. The non-transitory, computer-readable storage medium of claim 16, wherein the post-reconstruction filtering syntax comprises Cross-Component Sample Offset (CCSO) frame-level parameters.

20. The non-transitory, computer-readable storage medium of claim 16, wherein the second flag that indicates whether to reuse a frame-level post-reconstruction filtering syntax for the previously coded frame for the post-reconstruction filtering process for the current frame, and the compressed bitstream comprises a third flag that indicates whether to reuse a block-level post-reconstruction filtering syntax for the previously coded frame for the post-reconstruction filtering process for the current frame.
